(19) United States
(12) Patent Application Publication
(10) Pub. No.: US 2007/0185248 A1
(43) Pub. Date: Aug. 9, 2007

(54) Intumescent polylefin nanocomposites and their use

(75) Inventors: Guoqiang Qian, Arlington Heights, IL (US); David A. Jarus, Shaker Heights, OH (US)

Correspondence Address: POLYONE CORPORATION, 33587 WALKER ROAD, AVON LAKE, OH, 44012, US

(73) Assignees: POLYONE CORPORATION, Avon Lake, OH (US); AMCOL INTERNATIONAL CORPORATION, Arlington Heights, IL (US)

(21) Appl. No.: 11/570,574

(22) PCT Filed: Jun. 16, 2005
(86) PCT No.: PCT/US05/21237

§ 371 Date: Dec. 13, 2006

Related U.S. Application Data
(60) Provisional application No. 60/582,954, filed on Jun. 25, 2004.

(51) Int. Cl. C08K 5/52

(52) U.S. Cl. 524/127; 524/236; 524/543; 524/445; 524/502

(57) ABSTRACT

An intumescent polyolefin nanocomposite is disclosed. The nanoclay contributes stiffness, toughness and flame retardancy to the compound. The intumescent contributes flame retardancy. The compound can be processed as a thermoplastic into any practical article needing stiff, tough, and flame retardancy properties.

### CLAIM OF PRIORITY

This application claims priority from U.S. Provisional Patent Application Ser. No. 60/582,954 bearing Attorney Docket Number 12004006 and filed on Jun. 25, 2004.

### FIELD OF THE INVENTION

This invention relates to polyolefin compounds containing nanoclays and intumescent materials.

### BACKGROUND OF THE INVENTION

Fire kills people and destroys property. Any material that offers flame retardance benefits the public. Flame retardants are often added to compounds to provide flame resistance to products made from such compounds.

Intumescent materials are used with polyolefin compounds to provide flame retardancy to polyolefin compounds. Intumescent materials are available from commercial sources such as Great Lakes Chemical Corporation (www.greatlakeschem.com) and Amfine Chemicals (www.amfine.com).

Nanoclays are exciting additives for a variety of purposes, including flame retardancy. U.S. Pat. Nos. 6,376,591; 6,251,980; 6,232,388; 6,225,394; 6,090,734; 6,050,509; 5,998,528; 5,844,032; and 5,837,763 disclose the manufacture and use of nanocomposites. Nanocor, Inc. is a significant commercial source of exfoliated or intercalated nanoclays and has a web site: www.nanocor.com. Also Polyone Corporation (www.polyone.com) is a source of Nanoblend™ nanoclay concentrates for use in polyolefin compounds.

U.S. Pat. No. 6,632,442 (Chyall et al.) discloses an intumescent polymer composition including an ionic phyllosilicate (i.e., a nanoclay), in which was taught a desire to limit or minimize expensive additives from a cost perspective. More particularly, Chyall et al. teach a well-defined range of loading levels for the clay additive, from about 0.1 to about 2 weight percent of the total composition. Chyall et al. also teach the operative test to pass is the Underwriters' Laboratories Inc. test: UL-94 with a V-0 rating.

### SUMMARY OF THE INVENTION

What the art needs is an intumescent polyolefin nanocomposite compound that has a higher loading of nanoclay to provide maximum benefit of nanoclay in a polyolefin compound containing intumescent flame retardant materials.

The present invention solves that problem in the art by providing an intumescent polyolefin nanocomposite which has more than 2 weight percent of nanoclay in the composition.

One aspect of the present invention is an intumescent polymer compound, comprising (a) a polyolefin; (b) an intumescent; (c) at least about 3 weight percent of the total compound of a nanoclay.

Another aspect of the present invention is an article made from the intumescent polymer compound described immediately above.

A feature of the present invention is that the nanoclay also provides stiffness and toughness to the intumescent polymer compound, while not otherwise detracting from the intumescent properties thereof.

Another feature of the present invention is that the nanoclay contributes to overall flame retardancy of the intumescent polymer compound by itself being resistant to flames. Nanoclays provide charring characteristics to reduce loss of structural integrity of the intumescent polymer compound in its engineered form.

An advantage of the present invention is that the intumescent polymer compound of the present invention can be processed as a thermoplastic material into practically any article of practically any shape with the properties of stiffness, toughness, and flame retardancy.

Another advantage of the present invention is the ability to make an article having flame retardancy which effectively diminishes incidence of dripping of molten polyolefins during burning of the article containing such polyolefins.

Another advantage of the present invention is that the intumescent polymer compound is essentially halogen-free, an advantage during combustion. “Essentially halogen-free” means that there is no intention to include any halogen moieties in any of the ingredients of the compound of the present invention, but that one can cannot control trace amounts of impurities that may exist in such ingredients.

Additional features and advantages will be identified below.

### EMBODIMENTS OF THE INVENTION

Polyolefin

“Polyolefin” includes homopolymers, copolymers, blends of polymers, mixtures of polymers, alloys of polymers, and combinations thereof, where at least one of the polymers is polymerized from an olefin monomer having from 2 to about 8 carbon atoms.

Within the broad definition above, non-limiting examples of polyolefins suitable for the present invention include polyethylene (including low-density (LDPE), high-density, high molecular weight (HDPE), ultra-high molecular weight (UHDPE), linear-low-density (LLDPE), very-low density, etc.), maleated polypropylene, polypropylene, polybutylene, polyhexalene, polyoctene, and copolymers thereof, and ethylene-vinyl-acetate (EVA) copolymer, and mixtures, blends or alloys thereof.

Particularly preferred is a blend of an olefin copolymer with a maleated polypropylene. The olefin copolymer is an ethylene-propylene copolymer, commercially available from Dow Chemicals under the Inspire brand. The maleated polypropylene is capable of increasing dispersion of nanoclay into the polyolefin, commercially available from Crompton Corporation under the Polybond brand.

Intumescent

Providing intumescence to a polyolefin polymer typically requires, as explained in Chyall et al., an acid source, a carbonific and spumific or nitrogen source component. These components may be in the same chemical compound. For example, ammonium polyphosphate will function as both an acid source and a nitrogen source as will be readily appreciated by one of skill in the art. Likewise, pentaerythritol phosphate alcohol (PEPA) functions as both an acid source and a carbonific. Melamine phosphate can provide carbon for the char, nitrogen for foaming and acid to catalyze dehydration and thus is a particularly preferred ingredient.

In some embodiments, the acid source and nitrogen source are supplied in whole or in part by way of a single chemical compound selected from the group consisting of: ammonium phosphate, ammonium polyphosphate, ammonium pyrophosphate and mixtures thereof.

Intumescent polymer compositions are those that foam and char to provide flame resistance, typically increasing in volume by more than 50 percent, preferably on the order of 100 percent based on the unreacted volume of the composition. The compositions thus typically include an acid catalyst source, a nitrogen source and a carbonific which may be the matrix polyolefin polymer itself or may be a polyol, or may be provided by way of a multifunctional ingredient such as pentaerythritol phosphate alcohol.

Acid sources may be borates, sulfates, sulfites, nitrates, phosphates, phosphonates, melamine or other salts of the foregoing, and so forth.

Additional examples of intumescent phosphorus-containing flame retardants include melamine salts of organophosphates such as melamine phenyl phosphate and melamine amyl phosphate.

There are many commercially available sources of intumescent materials, in any of the combinations described above. A preferred commercial source of intumescent material is Amfine, identified above, and particularly its Amfine FP 2000 brand nitrogen-phosphorous based flame retardant product.

Nanoclay

Nanoclay is a clay from the smectite family. Smectites have a unique morphology, featuring one dimension in the nanometer range. Montmorillonite clay is the most common member of the smectite clay family. The montmorillonite clay particle is often called a platelet, meaning a sheet-like structure where the dimensions in two directions far exceed the particle's thickness.

Nanoclay becomes commercially significant if intercalated with an intercalant. An intercalate is a clay-chemical complex wherein the clay gallery spacing has increased, due to the process of surface modification by an intercalant. Under the proper conditions of temperature and shear, an intercalate is capable of exfoliating in a resin matrix. An intercalant is an organic or semi-organic chemical capable of entering the montmorillonite clay gallery and bonding to the surface. Exfoliation describes a dispersion of a surface treated nanoclay in a plastic matrix.

In exfoliated form, nanoclay platelets have a flexible sheet-type structure which is remarkable for its very small size, especially the thickness of the sheet. The length and breadth of the particles range from 1.5 μm down to a few tenths of a micrometer. However, the thickness is astoundingly small, measuring only about a nanometer (a billionth of a meter). These dimensions result in extremely high average aspect ratios (200-500). Moreover, the miniscule size and thickness mean that a single gram contains over a million individual particles.

Nanocomposites are the combination of the surface treated nanoclay and the plastic matrix. In polymer compounding, a nanocomposite is a very convenient means of delivery of the nanoclay into the ultimate compound, provided that the plastic matrix is compatible with the principal polymer resin components of the compounds. In such manner, nanocomposites are available in concentrates, masterbatches, and compounds from Nanocor, Inc. of Arlington Heights, Ill. (www.nanocor.com) and Polyone Corporation of Avon Lake, Ohio (www.polyone.com) in a variety of nanocomposites.

Nanocomposites offer flame-retardancy properties because such nanocomposite formulations burn at a noticeably reduced burning rate and a hard char forms on the surface. They also exhibit minimum dripping and fire sparkling.

In the present invention, the intumescent polymer compound has intercalated nanoclay added to the polyolefin matrix, such that the polymer compound of the present invention is termed an intumescent polyolefin nanocomposite. A particularly preferred intercalated nanoclay is I44P from Nanocor, Inc.

Table 1 shows ranges of acceptable, desirable, and preferred weight percents of the various ingredients of the intumescent polymer nanocomposite compound, relative to the total weight of the compound, all being expressed in approximate values, for a preferred embodiment of the invention.

TABLE 1
Weight Percent of Resin Ingredients to Total Compound

| | Acceptable | | |
|---|---|---|---|
| Polymer | (Wt. %) | Desirable (Wt. %) | Preferred (Wt. %) |
| Ethylene-Propylene | 46-75.5 | 63-72.5 | 66-72 |
| Copolymer | | | |
| Maleated | 0-10 | 0.5-3 | 1-2.5 |
| Polypropylene | | | |
| Polyolefin Subtotal | 56-75.5 | 66-73 | 68.5-73 |
| Nanoclay | 2.5-4 | 3-4 | 3-3.5 |
| Intumescent | 22-40 | 24-30 | 24-28 |

Optional Additives

As with any polymeric resin-based compound, optional additives can provide easier processing and more desirable final appearance and properties for the compound.

Non-limiting examples of optional additives include fillers, antioxidants, stabilizers, lubricants, pigments, biocides, and the like. None of these ingredients is essential to the performance of the compound as a flame-retardant polymeric material. But each of them can provide added value to the final compound when included for their intended purpose. Each of these additives is commercially available from well-known sources known to those skilled in the art.

For example, fillers can range from about 1 to about 10, and preferably from about 2 to about 3 weight percent of the compound.

Antioxidants can range from about 0.03 to about 0.1, and preferably from about 0.05 to about 0.07 weight percent of the compound.

Stabilizers can range from about 0.1 to about 0.5, and preferably from about 0.11 to about 0.13 weight percent of the compound.

Lubricants can range from about 0.1 to about 1, and preferably from about 0.7 to about 0.8 weight percent of the compound.

Pigments can range from about 0 to about 20, and preferably from about 10 to about 11 weight percent of the compound.

Biocides can range from about 0.5 to about 5, and preferably from about 2 to about 3 weight percent of the compound.

Method of Making Compound

Compounding the compound of the present invention can take any number of routes according to preferences of those familiar with the compounding of thermoplastic materials. In one route, each ingredient is mixed into a large vessel. In another route, batches of ingredients are first formed and then the batches are combined.

As preferred in the present invention, the following well-known steps can be employed in the following sequence: blenders containing ingredients feeding a hopper upstream from an extruder, usually twin-screw, co-rotating. The ingredients are thoroughly mixed under sufficient heat to melt the polyolefins.

Preferably, the mixing equipment is a co-rotating twin-screw extruder commercially available from Werner-Pfleiderer. The extruder should be capable of screw speeds ranging from about 50 to about 2,000 rpm. The temperature profile from the barrel number two to the die should range from the melting temperature of the thermoplastic matrix polymer to about 270° C., and preferably from around 200° C. for this nanoconcentrate. The nanocomposite can be pelletized for later use in the formation of articles as described below.

### USEFULNESS OF THE INVENTION

Using conventional extrusion, molding, calendering, or other form-generating production equipment, the compound of the present invention can be made into a variety of forms. The intumescent flame-retardant properties of the compound resides throughout the mass of the compound, whatever its form. Non-limiting examples of forms are films, profiles, articles, fibers, and the like.

Films can have dimensions ranging from about 0.2 mm to about 0.5 mm (8 to 20 mils), and preferably from about 0.2 mm to about 0.3 mm in thickness and ranging from about 40 cm to about 187 cm (16 to 74 inches), and preferably from about 71 cm to about 162 cm in width. Length is generally dependent on the size of a roll of the film. Films can be solid or be a membrane, depending on means of formation according to techniques known to those of skill in the art. Films can be reinforced or unreinforced, according to techniques known to those skilled in the art.

Profiles can also be made from extrusion of compounds of the present invention of any three-dimensional shape according to the shape of the profile die used during extrusion.

Articles can be made from a mold using compounds of the present invention according to any cavity shape of the mold, whether male or female and whether formed via heat, heat and pressure, heat and vacuum, or the like.

Fibers can be made of the compounds of the present invention, whether in the form of woven fibrous structures or nonwoven fibrous structures, according to production techniques known to those skilled in the art.

Articles made from compounds of the present invention are more valuable because nanoclays provide increased lightness and stiffness while retaining toughness and because nanoclays in concentrations more than 2 percent by weight also contribute to the flame retardancy properties of the intumescent. Such articles can be made into any number of shapes, among them, automobile parts, large appliance parts, and the like.

Regardless of desired form, made using teachings from encyclopedia, technical literature, or patent literature, the flame-retardant properties of the compound drive which form is employed.

The following examples further explain the invention.

### EXAMPLES

Examples 1-2 and Comparative Examples A-B

Nanoclay-containing intumescent composites were prepared according to the recipes and commercial sources stated in Table 1 and the mixing conditions stated in Table 2.

TABLE 1
Concentrate Recipes for Use in TPO

| Ingredient Wt. % | Comp. A | 1 | Comp. B | 2 |
|---|---|---|---|---|
| Nanoclay | 2 | 3 | 2 | 3 |
| Intumescent | 24 | 24 | 26 | 26 |
| PP-g-MAH | 1.5 | 2.25 | 1.5 | 2.25 |
| Copolymer | 72.3 | 70.55 | 70.3 | 68.55 |
| Process Stabilizer | 0.2 | 0.2 | 0.2 | 0.2 |

Commercial Sources

| Ingredient and Use | Source | Brand(s) |
|---|---|---|
| Nanoclay to enhance stiffness | Nanocor | I44P |
| Nitrogen-Phosphorus Intumescent | Amfine | FP2000 |
| PP-g-MAH (maleated polypropylene) to | Crompton | PolyBond PBX5104 |
| disperse nanoclay into copolymer | | |
| Ethylene-Propylene Copolymer | Dow | Inspire 114 |
| Phosphite/phenolic process stabilizer | Ciba | B225 |

TABLE 2
Compound Making Conditions

| Example | | | |
|---|---|---|---|
| 1 | 2 | 3 | 4 |

| | |
|---|---|
| Mixing Equipment | Werner & Pfleiderer ZSK 25 co-rotating twin |
| | screw extruder |
| Mixing Temperature | 200° C. |
| Mixing Speed | 500 rpm |
| Order of Addition | About 58% of the copolymer is added through |
| | Feeder 1; all other ingredients are added through |
| | Feeder 2; the remainder of copolymer is added |
| | through Feeder 3 |

The invention is not limited to these embodiments. The claims follow.

What is claimed is:

1. An intumescent polymer compound, comprising:
(a) a polyolefin;
(b) an intumescent;
(c) at least about 3 weight percent of the total compound of a nanoclay.

2. The compound of claim 1, wherein the polyolefin is selected from the group consisting of homopolymers, copolymers, blends of polymers, mixtures of polymers, alloys of polymers, and combinations thereof, where at least one of the polymers is polymerized from an olefin monomer having from 2 to about 8 carbon atoms.

3. The compound of claim 2, wherein the polyolefin comprises polyethylene, maleated polypropylene, polypropylene, polybutylene, polyhexalene, polyoctene, ethylene-vinyl-acetate (EVA) copolymer, copolymers, mixtures, blends or alloys thereof.

4. The compound of claim 1, wherein the polyolefin is a blend of an ethylene-octene copolymer and a maleated polypropylene.

5. The compound of claim 1, wherein the intumescent comprises an acid source and a nitrogen source.

6. The compound of claim 5, wherein the acid source is selected from the group consisting of borates, sulfates, sulfites, nitrates, phosphates, phosphonates, melamines, and combinations thereof.

7. The compound of claim 5, wherein the intumescent is selected from the group consisting of melamine phenyl phosphate, melamine amyl phosphate, ammonium phosphate, ammonium polyphosphate, ammonium pyrophosphate, and combinations thereof.

8. The compound of claim 1, wherein the nanoclay is exfoliated.

9. The compound of claim 1, further comprising fillers, antioxidants, stabilizers, lubricants, pigments, biocides, or combinations thereof.

10. The compound of claim 1, wherein polyolefin comprises from about 56 to about 85 weight percent of the compound, wherein the nanoclay comprises from about 2.5 to about 4 weight percent of the compound, and wherein the intumescent comprises from about 22 to about 40 weight percent of the compound.
